(19) United States
(12) Patent Application Publication
(10) Pub. No.: US 2026/0074590 A1
(43) Pub. Date: Mar. 12, 2026

(54) ENERGY HARVESTING SYSTEMS FOR LOCKING DEVICES

(71) Applicant: Sargent Manufacturing Company, New Haven, CT (US)

(72) Inventor: Daniel W. Riley, Meriden, CT (US)

(73) Assignee: Sargent Manufacturing Company, New Haven, CT (US)

(21) Appl. No.: 19/300,108

(22) Filed: Aug. 14, 2025

Related U.S. Application Data
(60) Provisional application No. 63/692,933, filed on Sep. 10, 2024.

(51) Int. Cl. H02K 7/18; F03G 5/06; H02K 7/108; H02K 7/116

(52) U.S. Cl. CPC H02K 7/1853; F03G 5/065; H02K 7/108; H02K 7/116

(57) ABSTRACT

Aspects disclosed herein relate to energy harvesting systems for electrified locking device assemblies and related methods. In some embodiments, an energy generating or harvesting system may collect mechanical energy from a locking system into functional electrical power for operating one or more access-control technologies. The energy harvesting systems of the present disclosure may collect mechanical energy from door handle being rotated in both directions. In other words, the energy harvesting system may be structured to convert mechanical energy from both the mechanical input of the user applying pressure to the handle, as well as the return of the handle back to the neutral position. In this way, the energy harvesting system may harvest energy from both directions of handle rotation, increasing the total energy harvested.

### CROSS-REFERENCE TO RELATED APPLICATIONS

This application claims the benefit under 35 U.S. C. § 119(e) to U.S. Provisional Application Ser. No. 63/692,933, entitled “ENERGY HARVESTING SYSTEMS FOR LOCKING DEVICES,”filed Sep. 10, 2024, which is incorporated herein by reference.

### FIELD

Disclosed embodiments relate to energy harvesting systems. More specifically, energy harvesting systems for, e.g., motorized locking device assemblies are disclosed.

### BACKGROUND

Conventional locking devices, such as mortise locks, employ a deadbolt to help secure or lock the door in place. In recent years, access-control technology in locking devices has increasingly shifted from traditional keying systems and mechanical articulation to digital monitoring and electronic actuation. In some instances, the digitization of locking devices has enabled remote locking and unlocking of doors with motors, sensors, and controllers.

### SUMMARY

In some embodiments, energy harvesting systems include an input shaft configured to rotate in a first rotational direction and a second rotational direction, a first rotatable assembly selectively rotatably coupled to the input shaft in the first rotational direction, a second rotatable assembly selectively rotatably coupled to the input shaft in the second rotational direction, and an output shaft configured to rotate in the first rotational direction when the input shaft is rotated in the first rotational direction, wherein the output shaft is configured to rotate in the first rotational direction when the input shaft is rotated in the second rotational direction.

In some embodiments, methods of energy harvesting include rotating an input shaft in a first rotational direction to drive an output shaft in the first rotational direction, the input shaft selectively rotatably coupled to a first rotatable assembly in the first rotational direction and a second rotatable assembly in a second rotational direction, and rotating the input shaft in the second rotational direction to drive the output shaft in the first rotational direction, the output shaft rotatably coupled to the first rotatable assembly.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIGS. 1A-1B show a schematic representation of a front view of an energy harvesting system according to some embodiments; and

FIG. 2 shows a schematic representation of a top view of the energy harvesting system of FIGS. 1A-1B.

### DETAILED DESCRIPTION

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

Modern locking devices increasingly include more access-control technology feature to enhance the accessibility and security of the locking devices. Access-control technology includes elements such as sensors, actuators, motors (e.g., motors to drive deadbolts and unlock or lock a door), solenoids, internet of things (IOT) sensors, indicators (e.g., LEDs), speakers, scanners (e.g., biometric scanners, proximity detectors, key card readers, keypads), among others. These elements typically require circuitry, auxiliary components (e.g., microcontrollers, memory storage elements), and power to operate. In most instances, the access-control technology and related features are all housed inside of a mortised recess or a lock housing of a door.

The Inventor has recognized that the increasingly electrified locking devices require greater amounts of energy for operation. Although high energy requirements can be fulfilled by high-capacity batteries, the Inventor has recognized that the limited real estate of conventional locking devices can pose significant challenges in supplying sufficient energy to operate electrified locking devices. Furthermore, the Inventor has recognized that the use of batteries in locking devices can require labor intensive and costly maintenance due to frequent battery repair and/or replacement.

The Inventor has recognized that although a conventional gearing system may be suitable for converting door handle rotation to electrical power in a first rotational direction (e.g., as the user applies pressure to the handle), no or minimal energy is converted through a second return rotation of the handle (e.g., as the handle is sprung back to its neutral position). In instances where the handle is directly engaged with a generator assembly including a motor, the return rotation might generate minimal energy, significantly reducing the overall amount of power that may be generated from the system. In this respect, the motor might still generate power on the return stroke, but the mechanical momentum from the first rotation will be lost (at the end of first rotation motor will stop and then reverse). This will lead to a slower rotation speed on the return stroke and less power generation.

In view of the foregoing, the Inventor has recognized the benefits associated with an energy harvesting system to capture all mechanical input to rotating door hardware, such as a door handle. For example, the motor would spin in the same direction on the return stroke of the handle, maintaining momentum to speed up the return stroke and extend the run down time. The system may convert the mechanical input (e.g., a user turning a lever handle of the door and upon the handle's return) into electrical energy to run the access-control technologies. In this way, the locking device may generate power to charge batteries and/or power the various access-control technologies, which may in turn reduce the need for costly maintenance and replacement of the battery. Of course, instances in which different benefits are offered by the systems and methods disclosed herein are also possible.

It should be appreciated that the present disclosure is not limited to use with door handles, as other door hardware may be employed, for example, door hinges, door closers, lock cylinders, or any other rotating hardware.

In some embodiments, an energy generating or harvesting system may collect mechanical energy from a rotatable hardware into functional electrical power for operating one or more access-control technologies. In one embodiment, the energy harvesting systems of the present disclosure may collect mechanical energy from door handle or other door hardware being rotated in both directions. In other words, the energy harvesting system may be structured to convert mechanical energy from both the mechanical input (e.g., of the user applying pressure to the handle), as well as the return of the hardware (e.g., handle) back to the neutral position. In this way, the energy harvesting system may harvest energy from both directions of hardware rotation, increasing the total energy harvested.

In one embodiment, the energy harvesting systems of the present disclosure may include an output motor which may spin in a constant rotational direction irrespective of the hardware rotation. Thus, in some embodiments, when the door hardware is rotated (e.g., a handle is rotated by a user) in a clockwise direction, the motor may spin in the clockwise direction, and when the door hardware is returned to its neutral position (e.g., with a spring) in the counterclockwise direction, the motor may continue spinning in the clockwise direction. In this way, the energy harvesting system may collect continuous rotational energy from the hardware to enhance the power generated from the system. The power may then be used to operate any number of access control technologies.

In some embodiments, the energy harvesting systems of the present disclosure may convert the mechanical energy associated with door hardware rotation into electrical power. The electrical power may be used to increase the lifespan of any batteries (and/or other energy storage devices, such as supercapacitors) within the locking device, and/or may be used to independently operate the electronic elements of the locking device. For example, the energy harvesting system itself may be used to directly drive a motor of a deadbolt assembly. In another example, the energy harvesting system may transfer power to a battery, which can be used to drive the motor of the deadbolt assembly at a specified time. It should be appreciated that the energy harvesting systems may be used to power any suitable element or combination of elements of a locking device, either directly or indirectly, as the present disclosure is not so limited.

It should be appreciated that the implementation of the energy harvesting systems of the present disclosure is not limited to locking devices of doors, and that the energy harvesting systems described herein may be used in any suitable application to capture mechanical energy of bidirectional rotation.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

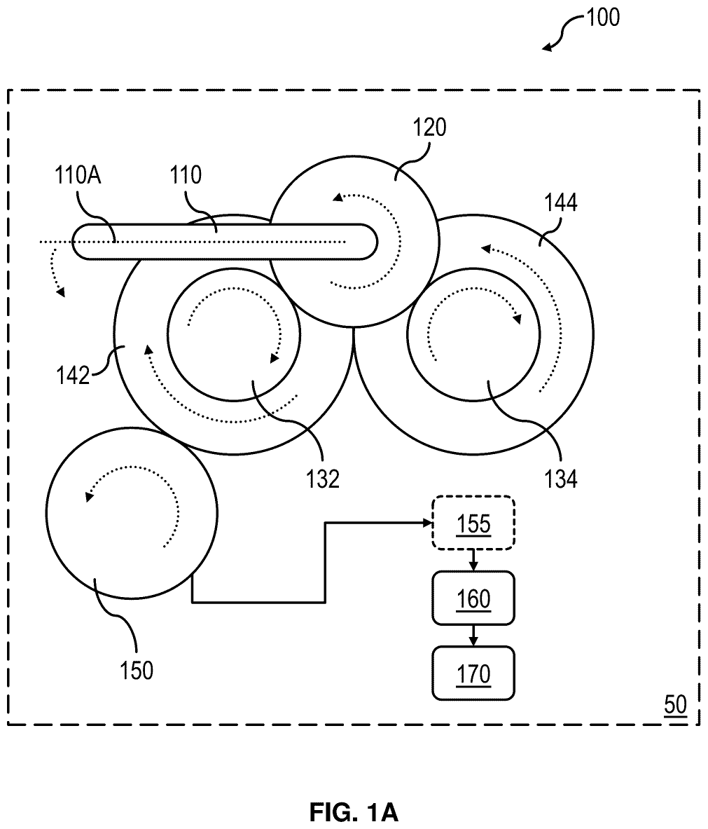

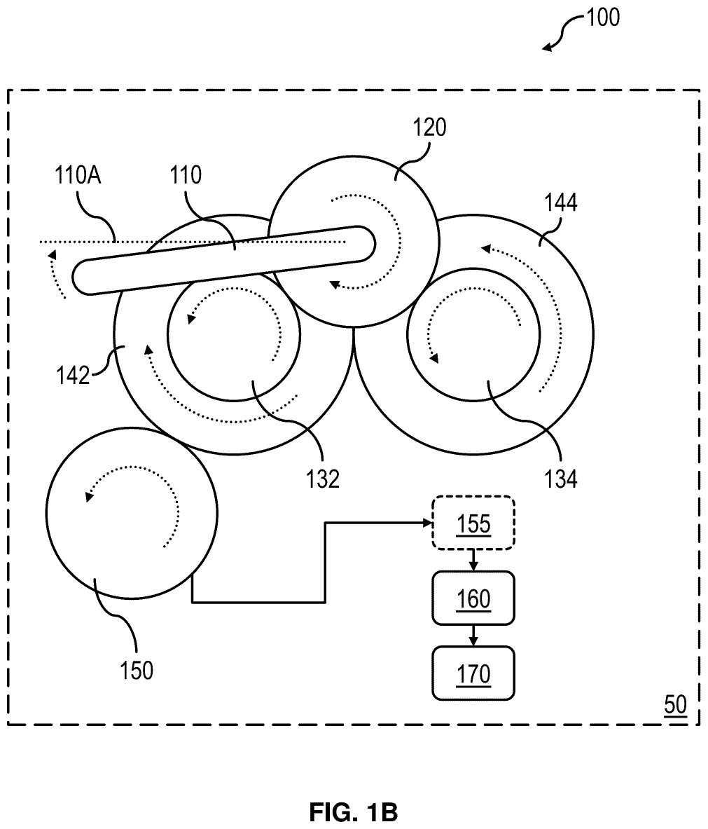

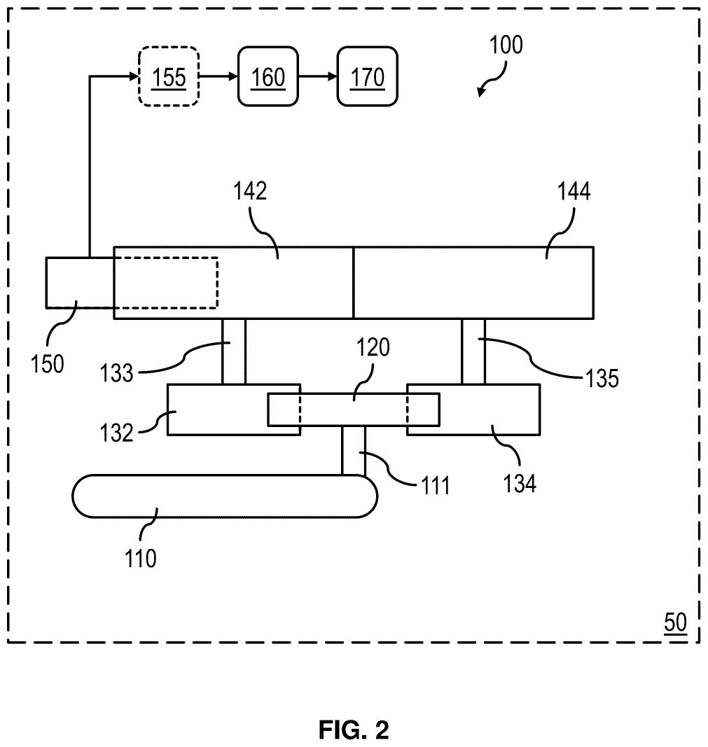

FIGS. 1A-2 show schematic representations of an energy harvesting system 100 according to some embodiments, with FIGS. 1A-1B schematically representing front views of the system and FIG. 2 schematically representing a top view of the system. In one embodiment, the energy harvesting system may be arranged within a recess or cavity of a door 50 or in a door lock and may be used to harvest power from the movement of a levered door handle 110. In some embodiments, the door handle 110 may be rotationally coupled to a handle gear 120 through a shaft 111, such that when a user rotates the handle away from the handle's neutral axis (see neutral axis 110A in FIGS. 1A-1B), the handle gear 120 may rotate along with the handle. In some embodiments, the shaft 111 may be engaged with the handle 110 and the handle gear 120 through a spindle (e.g., a square-hole spindle), to ensure efficient load transfer from the user to the handle gear 120. In other words, the connection between the handle 110 and handle gear 120 may be arranged in a manner that reduces frictional losses, which may reduce the overall energy harvested from the system. In some embodiments, the shaft 111 may serve as an input shaft.

It should be appreciated that although the figures are described with reference to a door handle, other door hardware may be employed as the present disclosure is not limited in this regard. Accordingly, for instance, the door handle 110 in the embodiment shown in the figures may be considered representative of a component of another piece of hardware, such as the arm of a closure device, or the leaf of a door hinge, etc. Similarly, the gear component to which the door handle is connected is referenced as a handle gear, though it should be appreciated that in embodiments not employing a door handle, the handle gear would simply be referred to as an input gear. That said, the below description will refence a door handle and handle gear.

As shown in FIGS. 1A-2, the energy harvesting system 100 may include a pair of clutches 132, 134, both of which may be engaged with a separate portion of the handle gear 120. Each clutch may be selectively rotationally coupled to a respective clutch gear through a shaft. As shown in FIGS. 1A-2, a first clutch 132 may be selectively rotationally coupled to a first clutch gear 142 through a first clutch shaft 133. In other words, the first clutch 132 may be configured to transfer torque from the handle gear 120 to the first clutch gear 142 in only one rotational direction. Similarly, a second clutch 134 may be selectively rotationally coupled to a second clutch gear 144 through a second clutch shaft 135. The second clutch 134 may be configured to transfer torque from the handle gear 120 to the second clutch gear 144 in only one rotational direction. In some embodiments, the first clutch gear 142 and the second clutch gear 144 may be engaged to one another, such that rotation of one clutch gear results in rotation of the other clutch gear.

It should be appreciated that the first clutch 132 and the second clutch 134 may be selectively rotationally coupled to their respective gears in opposing directions. Thus, if the first clutch is rotationally coupled to the first clutch gear in a counterclockwise direction, then the second clutch may be rotationally coupled to the second clutch gear in a clockwise direction, and vice versa. Thus, regardless of the direction of rotation of the handle 110, one of the clutches may be engaged and driving its respective clutch gear while the other clutch may be overrunning, and rotationally uncoupled from its clutch gear.

In some embodiments, the first clutch 132 may be rotationally coupled to the first clutch gear 142 in a counterclockwise direction and the second clutch 134 may be rotationally coupled to the second clutch gear 144 in a clockwise direction. Accordingly, due to the engagement between the first clutch 132 and the handle gear 120, when the handle gear 120 is rotating in a counterclockwise direction (e.g., when a user applies a downward force on the handle, shown by the arrow of FIG. 1A), the first clutch 132 may rotate against with the handle gear 120 in a clockwise direction, driving the first clutch gear 142 in the clockwise direction because the first clutch 132 may be rotationally engaged with the first clutch gear 142. In such embodiments, the second clutch 134 may only be rotationally coupled to the second clutch gear 144 in the counterclockwise direction. Thus, as the handle 110 and handle gear 120 rotate in the counterclockwise direction, and the first clutch 132, and first clutch gear 142 rotate in a clockwise direction, the second clutch 134 may be overrunning and rotating in the clockwise direction, allowing the second clutch gear 144 to rotate in the counterclockwise direction along with the first clutch gear 142 with limited resistance.

Similarly, when the handle 110 is returned to its neutral axis 110A through a clockwise rotation (e.g., through a spring return), as shown in FIG. 1B, the handle gear 120 may also rotate in a clockwise direction, driving the first clutch 132 and the second clutch 134 in a counterclockwise direction. Due to the counterclockwise engagement of the second clutch 134 and the second clutch gear 144, the second clutch gear 144 may subsequently be driving in a counterclockwise direction, while the first clutch 132 may be overrunning and permitting the first clutch gear 142 to rotate in the clockwise direction without significant resistance.

Accordingly, regardless of the direction of rotation of the handle 110 and associated handle gear 120, the first clutch gear 142 may only rotate in one direction (e.g., counterclockwise) and the second clutch gear 144 may only rotate in the opposite rotational direction (e.g., clockwise). It should be appreciated that embodiments in which the first clutch is rotationally coupled to the first clutch gear in a clockwise direction and the second clutch is rotationally coupled to the second clutch gear in a counterclockwise direction are also contemplated.

In some embodiments, one of the clutch gears may be coupled to an output gear. For example, as shown in FIGS. 1A-2, an output gear 150 may be coupled to a first clutch gear 142. Based on the rotational relationships described above, the output gear 150 may only be driven in one rotational direction, regardless of the direction of rotation of the handle 110. For example, as shown in FIGS. 1A-1B, regardless of whether the handle 110 is being rotated in a counterclockwise direction by a user (FIG. 1A) or the handle is returning to its neutral axis 110A through a spring assembly (FIG. 1B), the output gear 150 may rotate in one direction. Thus, the output gear 150 may be driven in a first rotational direction when the handle is rotated in a clockwise direction (e.g., a user applying pressure to the handle) and in the same first rotational direction when the handle is returned to its neutral axis (e.g., through a spring return). In this way, the output gear 150 may collect rotational energy from both directions of rotation. In some embodiments, the output gear 150 may be coupled to an output shaft, which may be directly or indirectly driving a motor or generator 160, such that the continuous rotation of the output gear 150 in one direction may result in continuous energy harvesting by the motor or generator. In this way, the energy harvesting system 100 may collect a maximal amount of rotational energy from forces applied to the handle.

In some embodiments, the energy harvesting system 100 may be electrically coupled to a motor or generator 160, which may convert the rotational energy of output gear 150 into electrical power. In some embodiments, an optional accelerator gear system 155 may be used to further amplify or otherwise adjust the rotational energy transfer to the motor 160. In some embodiments, a shaft or other torsion transfer device may directly transfer the rotationally energy of the output gear 150 to the motor 160. In some embodiments, the motor or generator 60 may convert the rotational energy of the output gear into electrical power. In some embodiments, the energy harvesting system 100 may include an energy harvesting circuit 170 which may include an energy storage element (e.g., a battery or supercapacitor) to store the generated power as well as circuity to deliver the generated power to elements of the locking device. It should be appreciated that the electrical power may be transferred to any suitable element in any suitable manner (e.g., through a battery and any number of auxiliary electrical components), as the present disclosure is not necessarily limited by the use of the generated power within the locking device.

The handle 110 may be any suitable handle conventionally used in locking devices. It should be appreciated that although a levered door handle is shown in FIGS. 1A-1B, the energy harvesting systems of the present disclosure may collect mechanical energy from any suitable bi-directionally rotating hardware, including door handles (levers, knobs), door closers, hinges. The door handles of the present disclosure may be operable to any suitable degree of rotation, including between 25° and 80° of rotation relative (e.g., above and/or below) the handle's neutral axis (see axis 110A in FIGS. 1A-1B). It should be appreciated that the energy harvesting systems of the present disclosure may not be limited by the operation or type of door handle of the locking device.

It should be appreciated that the clutches of the present description may be any suitable clutches which may reduce frictional losses and maximize the amount of generated power. The clutches of the present disclosure may be any one-way clutches, including, but not limited to, clutches with a pawl and teeth assembly, one-way clutches, bearing clutches, spring-wrap clutches, and/or any other suitable clutches, as would be appreciated by those skilled in the art.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

What is claimed is:

1. An energy harvesting system, the system comprising;
an input shaft configured to rotate in a first rotational direction and a second rotational direction;
a first rotatable assembly selectively rotatably coupled to the input shaft in the first rotational direction;
a second rotatable assembly selectively rotatably coupled to the input shaft in the second rotational direction; and
an output shaft configured to rotate in the first rotational direction when the input shaft is rotated in the first rotational direction, wherein the output shaft is configured to rotate in the first rotational direction when the input shaft is rotated in the second rotational direction.

2. The system of claim 1, wherein the input shaft is rotationally coupled to a door hardware.

3. The system of claim 1, wherein the first rotatable assembly comprises a first clutch and a first clutch gear, and wherein the first clutch is selectively rotatably coupled to the first clutch gear.

4. The system of claim 3, wherein the second rotatable assembly comprises a second clutch and a second clutch gear, and wherein the second clutch is selectively rotatably coupled to the second clutch gear.

5. The system of claim 4, wherein the first clutch gear is engaged with the second clutch gear.

6. The system of claim 4, further comprising an input gear rotatably coupled to the input shaft.

7. The system of claim 6, wherein the input gear is engaged with the first clutch and the second clutch.

8. The system of claim 1, wherein the output shaft is rotationally coupled to an energy generator.

9. A method of energy harvesting, the method comprising:
rotating an input shaft in a first rotational direction to drive an output shaft in the first rotational direction, the input shaft selectively rotatably coupled to a first rotatable assembly in the first rotational direction and a second rotatable assembly in a second rotational direction; and
rotating the input shaft in the second rotational direction to drive the output shaft in the first rotational direction, the output shaft rotatably coupled to the first rotatable assembly.

10. The method of claim 9, wherein rotating the input shaft comprises rotating a door hardware.

11. The method of claim 9, further comprising transferring rotational energy from the output shaft to an energy generator.
